(19) United States
(12) Patent Application Publication
(10) Pub. No.: US 2009/0276837 A1
(43) Pub. Date: Nov. 5, 2009

(54) CREDENTIAL EQUIVALENCY AND CONTROL

(75) Inventors: David Abzarian, Kirkland, WA (US); Todd L. Carpenter, Monroe, WA (US); Harish S. Kulkarni, Redmond, WA (US); David John Steeves, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/113,191

(22) Filed: Apr. 30, 2008

(51) Int. Cl. H04L 9/32

(52) U.S. Cl. 726/5

(57) ABSTRACT

A number of equivalent credentials may be associated with at least one entity. Each of the equivalent credentials may be of one of a number of types, such as, for example, a cryptographic key pair, a password, a biometric, or other types or combinations thereof. When one of the equivalent credentials is authenticated by an authentication control system, the at least one entity may be permitted access to a hardware device, software, or a service associated with the authentication control system. The authentication control system may include a number of authentication endpoints and blocking controls, each of which may be associated with a respective equivalent credential. After the authentication control system authenticates one of the equivalent credentials, a parameter of a blocking control and/or configurable credential-related attributes of an authentication endpoint associated with another of the equivalent credentials may be changed or reset.

### BACKGROUND

Typically, hardware devices, network services, and other off-host applications rely on user password credentials when authenticating a user. However, passwords may be easily forgotten and are most susceptible to brute force attacks in comparison with other types of credentials. One solution, with respect to susceptibility to brute force attacks, may include password complexity policies and anti-hammering. However, password complexity policies and anti-hammering may increase usability complexity and may further increase a likelihood that a user may forget a password and/or be blocked from further authentication attempts.

Anti-hammering is a security feature which blocks authentication attempts once a predefined maximum number of successive failed authentication attempts occur. Generally, services that implement anti-hammering, with respect to password authentication, provide a password reset or recovery mechanism. The password reset or recovery mechanism may prompt a user to answer common questions for reset purposes and may send an e-mail including a reset password to an e-mail address of record. Such mechanisms may be less secure than an original password, depending on the common questions asked, or security of e-mail.

One solution for improving user experience, with respect to password authentication, includes caching a password such that the user may be authenticated without entering a password at every session. Because users tend to use a same password for multiple services, caching a password has negative security implications. As an example, if a malicious user happens to retrieve a cached password, the malicious user may gain access to additional services on behalf of a legitimate user.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

In embodiments consistent with the subject matter of this disclosure, a method and a system may provide credential equivalency. A number of equivalent credentials may be associated with one or more entities. One of the equivalent credentials may be received by an authentication control system. The authentication control system may attempt to successfully authenticate the received one of the equivalent credentials. After any of the equivalent credentials are successfully authenticated, the one or more entities may be permitted to access hardware, software, or a service, associated with a user. Each of the equivalent credentials may be associated with a blocking control and an authentication endpoint of the authentication control system. After a predetermined number of successive failed authentication attempts, a blocking control associated with a same type of equivalent credential as an equivalent credential received during the successive failed authentication attempts may be blocked. Each of the authentication endpoints may have a number of configurable attributes which may affect operation of the respective authentication endpoints.

Upon successful authentication of an equivalent credential associated with one of the authentication endpoints, a blocking parameter of a blocking control associated with other equivalent credentials and/or configurable attributes of an authentication endpoint associated with the other equivalent credentials may be changed or reset. In some embodiments, only one or more blocking parameters of one or more blocking controls and/or configurable attributes, associated with one or more authentication endpoints and corresponding equivalent credentials, which have respective strengths less than or equal to a strength of the successfully authenticated equivalent credential, may be changed or reset.

### DRAWINGS

In order to describe the manner in which the above-recited and other advantages and features can be obtained, a more particular description is described below and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates a functional block diagram of an exemplary processing device, which may be used with embodiments consistent with subject matter of this disclosure.

FIG. 2 is a functional block diagram of an exemplary authentication control system consistent with the subject matter of this disclosure.

FIG. 3 shows an authentication endpoint of an authentication control system with exemplary configurable credential-related attributes.

FIG. 4 illustrates an exemplary environment in which embodiments consistent with the subject matter of this disclosure may be used.

FIGS. 5 and 6 are flowcharts illustrating exemplary processes which may be performed in embodiments consistent with the subject matter of this disclosure.

### DETAILED DESCRIPTION

Embodiments are discussed in detail below. While specific implementations are discussed, it is to be understood that this is done for illustration purposes only. A person skilled in the relevant art will recognize that other components and configurations may be used without parting from the spirit and scope of the subject matter of this disclosure.

### Overview

Embodiments consistent with the subject matter of this disclosure may provide a method and an access control mechanism by which any one of a number of equivalent credentials, associated with one or more entities, may be provided for authentication purposes in order to gain access to a hardware device, software, or services. Each of the equivalent credentials may be associated with a respective authentication endpoint. Each of the authentication endpoints may further be associated with a blocking control, such that when a predetermined number of successive failed authentication attempts occur, with respect to an authentication endpoint, a corresponding blocking control may block future authentication attempts with respect to the authentication endpoint. A second equivalent credential of the equivalent credentials may then be provided for authentication purposes. After successful authentication of the second equivalent credential, a parameter of the blocked blocking control may be changed or reset. For example, the predetermined number of successful attempts, with respect to the blocked blocking control, may be changed after the successful authentication of the second equivalent credential, or the blocked blocking control may be unblocked.

Each of the authentication endpoints may further be associated with a number of configurable credential-related attributes such as, for example, an equivalent credential, a type of the equivalent credential, a strength of the equivalent credential, an indication of whether the equivalent credential is enabled or disabled with respect to a respective one of the authentication endpoints, and/or other configurable credential-related attributes. After the successful authentication of the second equivalent credential, the configurable credential-related attributes associated with another of the authentication endpoints may be changed. For example, if the other of the authentication endpoints is associated with a password equivalent credential then a password associated with the password equivalent credential may be changed after the successful authentication of the second equivalent credential.

Each of the equivalent credentials may be one of a number of types. The types may include an asymmetric cryptographic key pair, a symmetric cryptographic key, a password, a biometric, and/or other types or combinations thereof. An asymmetric cryptographic key pair type of equivalent credential may be, for example, a Public Key Infrastructure (PKI) cryptographic key pair, or other asymmetric cryptographic key pair. A biometric type of equivalent credential may be, for example, a fingerprint, a voice print, a retinal scan, or other type of a biometric identifier.

Each of the equivalent credentials may have an associated strength based on a security level of the equivalent credential. For example, a cryptographic key type of equivalent credential may have a greater strength than a password type equivalent credential.

In some embodiments consistent with the subject matter of this disclosure, in order to change a parameter of a blocking control or configurable credential-related attributes, with respect to an authentication endpoint, a strength of the second equivalent credential may be greater than or equal to a strength of an equivalent credential associated with an authentication endpoint having one or more associated parameters or credential-related attributes to be changed or reset.

### Exemplary Processing Device

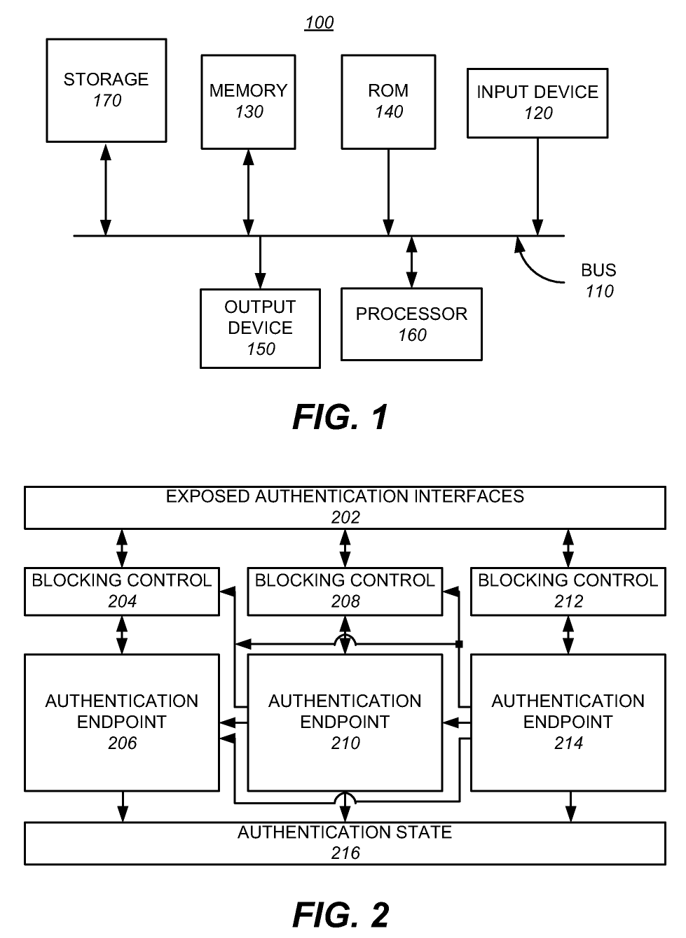

FIG. 1 is a functional block diagram of an exemplary processing device 100, which may be used with embodiments consistent with the subject matter of this disclosure. Processing device 100 may include a bus 110, an input device 120, a memory 130, a read only memory (ROM) 140, an output device 150, a processor 160, and a storage 170. Bus 110 may permit communication among components of processing device 100.

Processor 160 may include at least one conventional processor or microprocessor that interprets and executes instructions. Memory 130 may be a random access memory (RAM) or another type of dynamic storage device that stores information and instructions for execution by processor 160. Memory 130 may also store temporary variables or other intermediate information used during execution of instructions by processor 160. ROM 140 may include a conventional ROM device or another type of static storage device that stores static information and instructions for processor 160. Storage 170 may include compact disc (CD), digital video disc (DVD), a magnetic medium, or other type of storage medium for storing data and/or instructions for processor 160.

Input device 120 may include a keyboard or other input device. Output device 150 may include one or more conventional mechanisms that output information, including one or more display monitors, or other output devices.

Processing device 100 may perform such functions in response to processor 160 executing sequences of instructions contained in a tangible machine-readable medium, such as, for example, memory 130, ROM 140, storage 170 or other medium. Such instructions may be read into memory 130 from another machine-readable medium or from a separate device via a communication interface (not shown).

### Exemplary Authentication Control System

FIG. 2 is a functional block diagram illustrating an embodiment of an exemplary authentication control system consistent with the subject matter of this disclosure. The exemplary authentication control system may be implemented in software or in hardware such as, for example, an application-specific integrated circuit (ASIC) or other hardware. The exemplary authentication control system may be used to authenticate an entity with respect to using a hardware device, software, or a service. Exemplary authentication control system may include exposed authentication interfaces 202, blocking controls 204, 208, 212, authentication endpoints 206, 210, 214, and an authentication state 216.

Exposed authentication interfaces 202 may include a set of exposed application program interfaces (APIs) for permitting applications to provision and manage credentials, as well as to submit credentials for authentication. Further, some applications may implement a user interface for permitting an entity to submit commands to manage credentials and to submit credentials for authentication. The applications may communicate with the exemplary authentication control system via exposed authentication interfaces 202.

Authentication endpoints 206, 210, 214, each of which may be associated with respective blocking controls 204, 208, 212 and may be associated with a credential having a type different from types of credentials associated with other authentication endpoints. For example, authentication endpoint 206 may be associated with a password credential, authentication endpoint 210 may be associated with a symmetric cryptographic key-pair credential, and authentication endpoint 214 may be associated with an asymmetric cryptographic key-pair credential. Each of the types of credentials may have respective strengths, which may be based on a level of security associated with the respective types. For example, a password credential may be weaker than a symmetric cryptographic key credential, which may be weaker than an asymmetric cryptographic key credential.

Blocking controls 204, 208, 212 may each have one or more parameters. One parameter may indicate whether a respective blocking control is blocked (not responding to authentication attempts) or unblocked. A second parameter may indicate a number of successive failed authentication attempts before the respective blocking control becomes blocked.

When a credential, from among a number of equivalent credentials, is successfully authenticated by an authentication endpoint, the hardware device, the software, or the service may be in authentication state 216, thus permitting access to the hardware device, the software, or the service, by one or more entities associated with the equivalent credentials. Further, after a credential is successfully authenticated, the one or more entities may be automatically provided security features with respect to one or more other equivalent credentials if the one or more other equivalent credentials are defined. For example, the one or more entities may be permitted to change or reset security features with respect to one or more authentication endpoints associated with other defined equivalent credentials. The security features may include a parameter of a blocking control such as, for example, a parameter indicating whether the blocking control is currently blocking or not blocking authentication attempts, or a parameter indicating a number of successive authentication attempts before the blocking control becomes blocked. The security features may further include a number of credential-related attributes associated with an authentication endpoint. In some embodiments, only security features of a blocking control or authentication endpoint associated with a credential having a strength weaker than or equal to a strength of an authenticated credential may be changed or reset. With respect to the authentication control system of FIG. 2, authentication endpoint 210 may be associated with a credential having a stronger strength than a credential associated with authentication endpoint 206, and authentication endpoint 214 may be associated with a credential having a stronger strength than the credential associated with authentication endpoint 210. When the credential associated with authentication endpoint 210 is authenticated, a security feature associated with authentication endpoint 206 or blocking control 204 may be changed or reset. When the credential associated with authentication endpoint 214 is authenticated, a security feature associated with authentication endpoint 214 or blocking control 208 may be changed or reset.

The authentication control system illustrated in FIG. 2 is exemplary. For example, the authentication control system is shown as having three authentication endpoints, each of which has a corresponding blocking control. In other embodiments, and authentication control system may have fewer authentication endpoints or more authentication endpoints, each of which may have a corresponding blocking control. Further, in some embodiments, after authentication of an equivalent credential, security features for resetting or changing one or more parameters of a blocking control and/or one or more configurable credential-related attributes associated with another equivalent credential and an authentication endpoint may be permitted regardless of a strength of the authenticated equivalent credential.

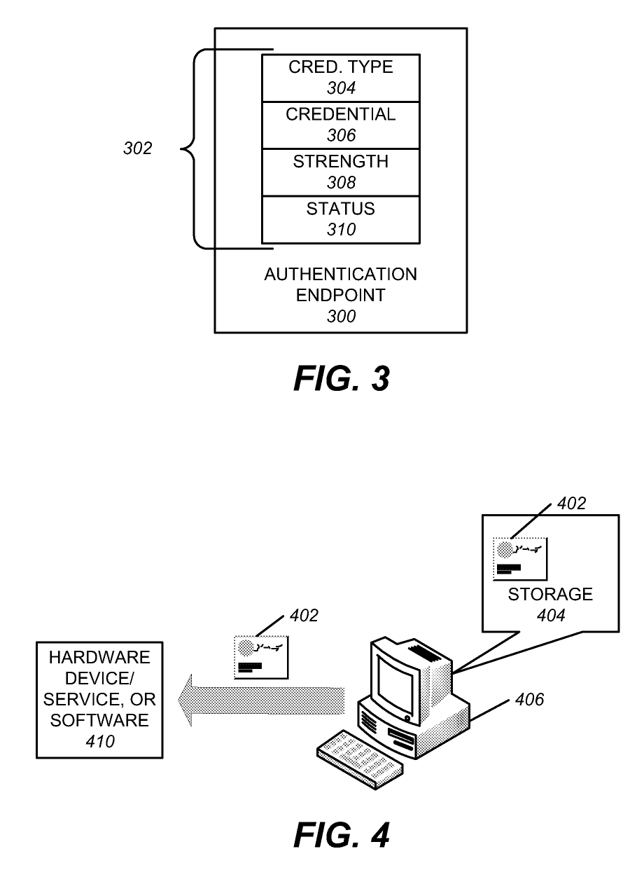

FIG. 3 illustrates an exemplary authentication endpoint 300 and associated credential-related attributes 302 in detail. Credential-related attributes 302 may include a credential type 304 of an associated credential, associated credential 306, a strength 308 of associated credential 306, and a status 310 of associated credential 306. Status 310 may indicate whether authentication endpoint 300 is enabled or disabled with respect to authenticating. When authentication endpoint 300 is disabled, authentication endpoint may be effectively deleted. When credential-related attributes are changed, an associated credential, a type of credential and/or a strength of a credential may be changed.

### Exemplary Environment

FIG. 4 illustrates an exemplary environment for use of a credential with an authentication control system of a hardware device, a service, or software. A processing device 406 may send a credential 402 to be authenticated by an authentication control system associated with a hardware device, a service, or software 410. If the authentication control system authenticates credential 402, then access to hardware device, service, or software 410 may be granted.

When processing device 406 is a trusted processing device, then credential 402 may be stored in storage 404 of processing device 406, such that processing device 406 may automatically supply credentials 402 to the authentication control system of hardware device, service, or software 410 without a user, or entity, providing credential 402. Further, in some embodiments, credential 402 may be a unique credential to be used only with the authentication control system associated with hardware device, service, or software 410. Thus, should credential 402 somehow be obtained by a malicious user, the malicious user may not use credential 402 for any other purpose.

### Exemplary Processes

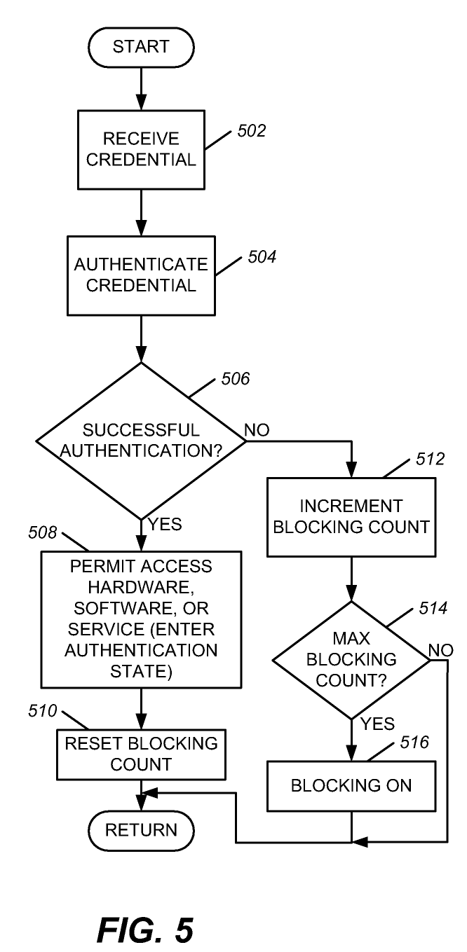

FIG. 5 illustrates a flowchart of an exemplary process which may be performed in an embodiment of an authentication control system. The process may begin with receiving a credential from among a number of equivalent credentials (act 502). The credential may then be authenticated by an authentication endpoint (act 504). For example, if the credential is a password type credential, the authentication endpoint may compare the received credential with an expected password. As another example, if the credential is a cryptographic key type credential, a cryptographic key corresponding to the received credential may be used to encrypt predefined text to produce an encrypted result. The authentication endpoint may compare the encrypted result with an expected result to determine whether the received credential is to be successfully authenticated.

Next, a determination may be made as to whether the received credential is successfully authenticated (act 506). If the credential is successfully authenticated, then one or more entities corresponding to the credential may be permitted access to a hardware device, software, or a service (act 508). The authentication control system may then reset a blocking control with respect to the received credential (act 510). Resetting of the blocking control may turn blocking off and may reset a count of successive failed authentication attempts with respect to the authentication endpoint.

If, during act 506, the authentication control system determines that the credential is not successfully authenticated, then a blocking count, associated with a same type of credential as the received credential, may be incremented (act 512). The blocking count may count a number of successive failed authentication attempts with respect to the same type of credential as the received credential. The authentication control system may then determine whether the blocking count is greater than a maximum value (act 514). The maximum value may be a number of successive failed authentication attempts permitted before blocking any additional authentication attempts. If the blocking count is determined to be greater then the maximum value, then blocking may be turned on or enabled (act 516) to block authentication attempts with respect to a same type of credential as the received credential. The process may then be completed.

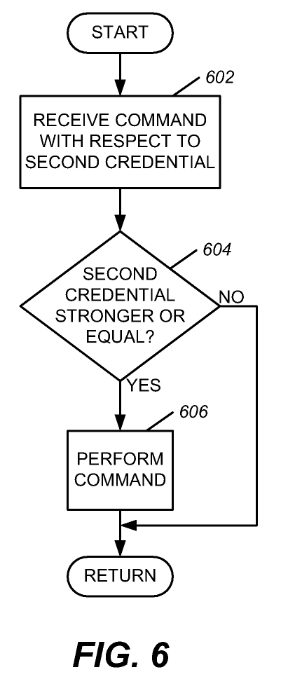

FIG. 6 is a flowchart illustrating exemplary processing with respect to an authentication control system receiving a command, with respect to a second authenticated equivalent credential, for changing or resetting a security feature associated with a first authentication endpoint corresponding to a first equivalent credential. The process may begin with receiving the command with respect to the second authenticated equivalent credential (act 602). The command may be included in a message with the second equivalent credential, or may be received in a message separate from the second equivalent credential. The authentication control system may then determine whether the second equivalent credential has a strength greater than or equal to a strength of the first equivalent credential (act 604). If the second equivalent credential has a strength greater than or equal to a strength of the first equivalent credential, then the command for changing or resetting the security feature associated with the first authentication endpoint may be performed (act 606). As previously mentioned, the security feature may include changing or resetting a parameter of a blocking control or changing or resetting configurable credential-related parameters. The process may then be completed.

### CONCLUSION

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Although the above descriptions may contain specific details, they are not to be construed as limiting the claims in any way. Other configurations of the described embodiments are part of the scope of this disclosure. Further, implementations consistent with the subject matter of this disclosure may have more or fewer acts than as described in FIGS. 5 and 6, or may implement acts in a different order than as shown in FIGS. 5 and 6. Accordingly, the appended claims and their legal equivalents define the scope of the invention, rather than any specific examples given.

We claim as our invention:

1. A machine-implemented method for providing credential equivalency, the machine-implemented method comprising:
receiving any one of a plurality of equivalent credentials associated with at least one entity, the plurality of equivalent credentials having a plurality of strengths;
authenticating the received any one of the plurality of equivalent credentials;
permitting the at least one entity to access one of a hardware device, software, or a service when the authenticating of the received any one of the plurality of equivalent credentials is successful; and
permitting the at least one entity to change or reset a security feature with respect to at least one other of the plurality of equivalent credentials when the authenticating of the received any one of the plurality of equivalent credentials is successful.

2. The machine-implemented method of claim 1, wherein the permitting of the at least one entity to change or reset a security feature with respect to at least one other of the plurality of equivalent credentials further comprises:
permitting the at least one entity to set a number of failed successive authentication attempts before blocking occurs with respect to the at least one other of the plurality of equivalent credentials.

3. The machine-implemented method of claim 1, wherein the permitting of the at least one entity to change or reset a security feature with respect to at least one other of the plurality of equivalent credentials further comprises:
permitting the at least one entity to unblock authentication of the at least one other of the plurality of equivalent credentials.

4. The machine-implemented method of claim 1, wherein only respective security features associated with ones of the plurality of equivalent credentials having weaker or equal strengths than a strength of the authenticated received any one of the plurality of equivalent credentials are reconfigurable when the authenticating is successful.

5. The machine-implemented method of claim 1, further comprising:
permitting the at least one entity to change or reset one other of the plurality of equivalent credentials when the authenticating of the received any one of the plurality of equivalent credentials is successful.

6. The machine-implemented method of claim 1, further comprising:
permitting the at least one entity to change or reset configurable credential-related attributes associated with only ones of the plurality of equivalent credentials having a weaker strength or an equal strength than the received any one of the plurality of equivalent credentials when the authenticating of the received any one of the plurality of equivalent credentials is successful.

7. The machine-implemented method of claim 6, wherein the permitting of the at least one entity to change or reset configurable credential-related attributes associated with only ones of the plurality of equivalent credentials having a weaker strength or an equal strength than the received any one of the plurality of equivalent credentials, further comprises:
permitting the at least one entity to disable, enable, or change any of the ones of the plurality of equivalent credentials having a weaker strength than the received any one of the plurality of equivalent credentials.

8. The machine-implemented method of claim 1, wherein each of the plurality of credentials is one of an asymmetric cryptographic key pair, a symmetric cryptographic key, a password, or a biometric identifier.

9. An authentication control system comprising:
a plurality of authentication endpoints, each of the authentication endpoints being associated with a respective one of a plurality of equivalent credentials, the plurality of equivalent credentials being further associated with at least one entity, each of the plurality of authentication endpoints placing one of a hardware device, software, or a service in an authenticated state when the respective associated one of the plurality of equivalent credentials is received; and
a plurality of configurable credential-related attributes and a blocking control associated with each of the plurality of authentication endpoints, the blocking control including at least one blocking parameter, ones of the plurality of authentication endpoints being capable of changing, associated with at least one other of the plurality of authentication endpoints, ones of the plurality of configurable attributes and ones of the at least one blocking parameter.

10. The authentication control system of claim 9, wherein only the ones of the plurality of authentication endpoints associated with a stronger or equal one of the plurality of equivalent credentials, with respect to the at least one other of the plurality of authentication endpoints, are capable of changing, associated with the at least one other of the plurality of authentication endpoints, the ones of the plurality of configurable attributes and the ones of the at least one blocking parameter.

11. The authentication control system of claim 9, wherein each of the plurality of equivalent credentials is one of a PKI cryptographic key-pair type credential, a symmetric cryptographic key type credential, a password type credential, or a biometric type credential.

12. The authentication control system of claim 11, wherein an authentication endpoint associated with the PKI cryptographic key-pair type credential is usable for resetting a password type credential associated with another authentication endpoint when the password type credential has a weaker or equal strength with respect to the PKI cryptographic key-pair type credential.

13. The authentication control system of claim 9, wherein:
the plurality of configurable credential-related attributes associated with each of the plurality of authentication endpoints comprise:
a type of an equivalent credential,
a strength of the equivalent credential,
the equivalent credential, and
an indication of whether the equivalent credential is enabled or disabled.

14. The authentication control system of claim 9, wherein the at least one blocking parameter comprises:
an indication of whether blocking of authentication attempts is active or inactive, and
a number of failed successive authentication attempts after which the blocking of authentication attempts becomes active.

15. A machine-implemented method for authenticating an entity, the machine-implemented method comprising:
authenticating a first one of a plurality of equivalent credentials associated with at least one entity, the at least one entity being permitted access to a hardware device, software or a service only after any one of the plurality of equivalent credentials is authenticated; and
automatically providing security features to the at least one entity, with respect to a second one of the plurality of equivalent credentials, when the second one of the plurality of equivalent credentials is defined.

16. The machine-implemented method of claim 15, further comprising:
receiving the first one of the plurality of equivalent credentials from a processing device, the first one of the plurality of equivalent credentials being automatically copied from a storage of the processing device and the processing device being a trusted processing device.

17. The machine-implemented method of claim 15, wherein the automatic providing of security features to the at least one entity, with respect to a second one of the plurality of equivalent credentials, is performed only when the first one of the plurality of equivalent credentials is a stronger credential or an equal credential with respect to the second one of the plurality of equivalent credentials.

18. The machine-implemented method of claim 15, wherein the automatic providing of security features to the at least one entity, with respect to a second one of the plurality of equivalent credentials, further comprises:
permitting the at least one entity to change or reset a blocking parameter or configurable credential-related attributed associated with the second one of the plurality of equivalent credentials only when the authenticating of the first one of the plurality of equivalent credentials is successful.

19. The machine-implemented method of claim 15, wherein the automatic providing of security features to the at least one entity, with respect to a second one of the plurality of equivalent credentials further comprises:
permitting the at least one entity to perform at least one of:
unblocking a blocking control associated with the second one of the plurality of equivalent credentials,
blocking the blocking control associated with the second one of the plurality of equivalent credentials,
modifying a number of successive failed authentication attempts, with respect to the second one of the plurality of equivalent credentials, before blocking further authentication attempts with respect to the second one of the plurality of equivalent credentials,
changing the second one of the plurality of equivalent credentials,
enabling the second one of the plurality of equivalent credentials,
disabling the second one of the plurality of equivalent credentials, or
deleting the second one of the plurality of equivalent credentials.

20. The machine-implemented method of claim 18, further comprising:
permitting the at least one entity to change or reset security features associated with others of the plurality of equivalent credentials only when the authenticating of the first one of the plurality of equivalent credentials is successful and a strength of the first one of the plurality of equivalent credentials is stronger than or equal to a respective strength of each of the others of the plurality of equivalent credentials.
